(19) United States
(12) Patent Application Publication
(10) Pub. No.: US 2006/0102088 A1
(43) Pub. Date: May 18, 2006

(54) Tensegrity marine structure

(75) Inventors: Anders Sunde Wroldsen, Trondheim (NO); Anne Marthine Rustad, Trondheim (NO); Tristan Perez, Trondheim (NO); Asgeir J. Sorensen, Flatasen (NO); Pal Lader, Trondheim (NO); Vegar Johansen, Trondheim (NO); Arne Fredheim, Trondheim (NO)

Correspondence Address: ROTHWELL, FIGG, ERNST & MANBECK, P.C., 1425 K STREET, N.W., SUITE 800, WASHINGTON, DC, 20005, US

(73) Assignee: NTNU Technology Transfer AS, TRONDHEIM (NO)

(21) Appl. No.: 11/010,378

(22) Filed: Dec. 14, 2004

(30) Foreign Application Priority Data
Nov. 12, 2004 (NO) 20044958

(51) Int. Cl. A01K 61/00

(52) U.S. Cl. 119/223; 119/215

(57) ABSTRACT

A marine structure like a fish cage (0) for aquaculture, with a net (90) spanned by a tensegrity structure, i.e. a structure comprising compressive elements (1), and tension elements (2).

### INTRODUCTION

The present invention relates to design concepts for flexible marine aquaculture structures. An extraordinary freedom to control shape, motion and vibration can be achieved by designing the system as a so-called tensegrity structure and by introducing appropriate actuation, sensing and control. A tensegrity structure comprises compressive elements like rods, and tensile elements like lines or wires, of which the compressive elements may not be under continuous compression. The invention also comprises interconnected units of flexible offshore structures.

### BACKGROUND OF THE INVENTION

Tensegrity structures are built up by compression members (bars), always in compression and tension members (strings), always in tension. This structure concept emerged from structural art in the late fifties and has been applied in civil engineering, structural engineering, architecture and aerospace engineering.

Fish farming and aquaculture installations are today located in sheltered areas close to shore or inside fiords. This is primarily due to the technological limitations and acceptable profits of this industry to date. The Norwegian export of fish and aquaculture products will in the future be of increasing importance for the nation and the industry is investigating into possibilities of exploiting fish farming offshore.

To date, the fish farming industry can be characterized by

Simple technological solutions.
Small to medium scale fish cage installations.
Limited flexibility of the structures.
Need of appropriate sheltered locations.
No shape, motion or vibration control of the installations.
   The main reasons for moving installations offshore are
Higher quality of water in open seas.
There will be larger flow-rate through the installations leading to an increase in the welfare of the fish.
Shortage of good locations for fish farming installations.
Large installations can increase the quantity and profit.
   The challenges of moving installations offshore with respect to structural design are
Large installations as net-keeping ring floaters and other structures need to be very rigid and strong, or highly flexible to cope with environmental loads, i.e. waves and currents.
Shape and motion control of the structure may be required both to optimize the welfare of the fish by altering the water flow and oxygen and to minimize the environmental loads.
Structure shape is of importance also with respect to transport of installations and harvesting of the fish.

### PRIOR ART

U.S. Pat. No. 3,063,521 to R. Buckminster-Fuller describes different aspects of the tensegrity design concept for building spherical shell structures, towers, beams and other structures. A basic element of Buckminster-Fullers structure is slender rods of which one end is connected by a tensile element to a second rod's end and a portion intermediate the ends of a third rod. Buckminster-Fuller has given name to the later carbon molecule structures C-60 called Buckminster-Fullerenes of similar structure. One possible disadvantage of attaching a tensile element to a portion intermediate the ends of a rod is the introduction of bending moments to the compressive elements, which may eventually break.

U.S. Pat. No. 3,169,611 to K. D. Snelson develops further aspects of tensegrity structures, displaying arcs and other art-like structures having purely compressive force fields along the bars, reducing the problem of bending moments of Buckminster-Fuller's compressive elements.

The introduction of controllable tensegrity structures can address the environmental load challenges of marine structures including fish cages for the open sea. This is due to the following properties of tensegrity structures:
The strength to mass ratio is very large. As the tensegrity structure may be designed to be flexible, a locally focused acting external force may be distriubuted to a multiple of elements of the structure, so as for attacking energy to be dissipated in the structure.
Any compressive element (bar) is subject to compression force only; thus no bars are subject to any torsion moment.
The compressive elements may be slender and we can expect most of the external forces acting on each compressive element and also on tensile elements, to be of viscous character, i.e. forces from fluid flows passing around a bar.
Tensegrity structures are perfect candidates for shape, motion and vibration control by adjusting the tension or/and length of the tensile elements (strings).
Tensegrity structures can also be developed such that propulsion can be achieved by proper interaction between subelements.

### SUMMARY OF THE INVENTION

The present invention representing a solution to the above mentioned problems, is a marine structure like a fish cage for aquaculture, with a net spanned by a tensegrity structure, i.e. a structure comprising compressive elements and tension elements.

In a preferred embodiment, the invention comprises a marine structure of in which the tensegrity structure comprises hexagonal cylindrical basic cells.

An other feature of a preferred embodiment comprises a tensegrity structure forming a flexibly deformable ring for being arranged near the surface or under the surface of the sea, for spanning said net hanging in the sea below the ring (and possibly floating above the ring, if the ring is submerged or if a so-called jump net is required) for enveloping a number of fish.

Alternatively to the tensegrity structure forming a ring holding a net, the tensegrity structure may form a flexibly deformable hemisphere spanning said net, said hemisphere (also spanning said net) for enveloping the fish.

More than constituting a hemisphere, in an alternative embodiment the tensegrity structure may form a flexibly deformable and closed, preferably tube-shaped structure for spanning said net.

Current marine aquaculture installations are mostly of small to medium size and have no active shape, motion or vibration control. We foresee that tensegrity structures in general would be a solution with respect to building flexible structures for rough environmental conditions experienced offshore. Proper sensing, actuation and control would in addition minimize environmental loads and optimize the welfare of the fish.

The invention hereby presented is embodied as marine installations using tensegrity structures. Proper sensing, actuation and control could be used to provide flexibility and adaptability of the structure. In particular, we introduce the novel ideas:
Application of an actuated tensegrity ring structure (FIG. 2a and FIG. 2b) to make the offshore structure flexible. The basic elements in this structure is an arrangement of three compression members crossing kept in a fixed spatial relationship by three tensile elements extending from each compressive element in a triangular short cylindrical cage-like structure with quadrangular side surface, with the compressive elements arranged diagonally in each quadrangle, please see FIG. 4. This basic element was first defined by K. D. Snelson in 1965.
Application of a second actuated tensegrity ring structure, please see FIG. 19, to make flexible offshore ring structures. The basic element in this structure is an octahedral cell (FIG. 19) presented by Passera & Pedretti at the Swiss Expo 2001. An interconnection between two basic elements with two joints and two tension members are shown in FIG. 20.
Application of a third actuated tensegrity ring structure (FIG. 23) to make flexible offshore structures. The basic elements in this structure is also the octahedral cell (FIG. 19). Two neighboring octahedral cells are now connected with only one joint and four tension members (FIG. 21).
A basic hexagonal cell (FIG. 12a) has been invented. A weave pattern is made by interconnecting such basic hexagonal cells as shown in the combined hexagonal cell (FIG. 13a). Actuation, primarily of tension members, can make the combined hexagonal cell change shape considerably between a wide and flat hexagonal prism as shown in FIG. 13b and a slender and high hexagonal prismatic bundle as in FIG. 13c.
The combined hexagonal cells (FIG. 13a) can be interconnected in several ways to form flexible structures. Different conceptual drawings have been made to indicate some of its various possible applications in fish farming installations (FIG. 14, FIG. 15, FIG. 16 and FIG. 17).
Interconnection of several installations built as tensegrity structures and exploit joint motion between the units to produce energy (FIG. 3). Shape, motion and vibration control is also the main issue for the interconnected structures.

### SHORT FIGURE CAPTIONS

The invention is illustrated in the attached drawings, which shall not be construed to be limiting the invention, which shall be limited by the attached claims only.

FIG. 1a is an introductory illustration of a plane view of a buoyancy ring of a fish cage.

FIG. 1b illustrates a plane view of a buoyancy ring of a fish cage, said cage containing live fish, and shaped to reduce the effect of environmental loads like waves, current, and wind.

FIG. 1c illustrates a plane view and a perspective view of a fish cage arranged athwart of the prevailing water current to more efficiently shift the water.

FIG. 2a illustrates a ring structure comprising several basic tensegrity elements (not illustrated to detail).

FIG. 2b illustrates the ring structures of FIG. 2a, having a general shape deviating from the shape of the ring structure of FIG. 2a, either by deformation or actively change of shape.

FIG. 3 shows a general plane view of several similarly shaped ring structures, e.g. of buoyancy rings of several fish cages, in which relative movements may be exploited for producing energy.

FIG. 4 shows a basic tensegrity element of Snelson shown in U.S. Pat. No. 3,169,611, having three compression members and 9 tension members forming a self-supported spatial structure. Snelson combines several such basic cells to form towers, arc structures, etc., in which compression is discontinuous and tension is continuous.

FIG. 5 shows two such combined basic cells of Snelson in which one is arranged on top of another, compression is discontinuous.

FIG. 6 illustrates that three such triangular cells of Snelson will have conflicting directions with resulting mechanical contact between the compression members, constituting a risk of fatigue or wear induced on crossing compression members. If used in a dynamic environment, e.g. in the sea or in shifting winds, this may incur damage to the entire structure building on such basic elements.

FIG. 7 illustrates a hexagonal basic element previously imagined to be used as a basic cell for building a multi-hexagonal structure, but having the potential problems of conflicting crossing directions of adjacent cells.

FIG. 8 is a simplified illustration of basic hexagonal and/or pentagonal cell elements imagined to form a spherical shell of inner and outer hexagonal and/or pentagonal areas formed by tension members, and imagined to have compressive elements (as shown in FIG. 9) connecting the inner and outer hexagonal and/or pentagonal areas.

FIG. 9 shows an effect of an embodiment of the present invention, the effect being the ability to compress or expand the area of a basic hexagonal cell, e.g. in order to compress a shell for transport, and expanding the shell after deploying it in the sea.

FIG. 10 is a view of the outline of a compressed basic hexagonal element, imagined to form a part of a compressed spherical shell of FIG. 8. The element is now redrawn to be consistent with the basic hexagonal cell of FIG. 12a.

FIG. 11 illustrates in more detail the outline of an expanded basic hexagonal element, imagined to form a part of an expanded spherical shell of FIG. 8. The element is now redrawn to be consistent with the basic hexagonal cell of FIG. 12a.

FIG. 12a illustrates an embodiment of a basic hexagonal cell of a hexagonal tensegrity element according to the invention.

FIG. 12b, FIG. 12c and FIG. 12d illustrate how three layers of the basic hexagonal cells displaced from one another can be combined to form the combined basic hexagonal tensegrity element according to the invention. Please see FIG. 13a.

FIG. 13b illustrates an expanded combined basic tensegrity element according to the invention, clearly showing a part of a first trusswork of six compressive elements connected in a hexagonal sawtooth pattern, part of a second trusswork of three compressive elements in a triangular pyramid shape, having their node point in the upper hexagonal plane and between three upper nodes in the sawtooth ring of said first trusswork, and part of a third, oppositely arranged triangular pyramidal trusswork of compressed elements.

FIG. 13c illustrates the same combined basic tensegrity element as shown in FIG. 13a and FIG. 13b, now compressed about a vertical axis of the hexagonal structure.

FIG. 14 shows a set of seven interconnected combined basic tensegrity element cells, no compression members shown.

FIG. 15 illustrates one single combined basic tensegrity element cell spanning a net, to illustrate that one single cell may be sufficient to form a fish cage.

FIG. 16 illustrates a tubular trusswork formed by several combined basic tensegrity element cells according to the invention, the tubular trusswork arranged in the sea and subject to waves.

FIG. 17 illustrates a tubular trusswork formed by several combined basic tensegrity element cells according to the invention, the tubular trusswork closed also by hexagonal members of the same type of basic tensegrity element. Such a closed trusswork may be arranged floating, neutral or with negative buoyancy in the sea and spanning an inside or outside net for forming a fish cage that may resist environmental loads.

FIG. 18 shows several fish cages having one shape while connected to a rigid structure moored, and having another shape adapted for being tugged by a tender.

FIG. 19 illustrated another basic tensegrity element according to the invention called an octahedral cell. The area inside of the four connected compressive elements may be provided with a net or impermeable surface.

FIG. 20 shows two connected octahedral cells of FIG. 19, forming part of a ring structure according to the invention as shown in FIG. 22. The two octahedral cells are joined along one side element of the four connected compressive elements.

FIG. 21 shows two octahedral cells connected in a node of the four connected compressive elements, having more freedom to move, and for forming an alternative ring structure as shown in FIG. 23.

FIG. 22 illustrates a plane view of a ring structure formed of octahedral cells of FIG. 19 and connected as shown in FIG. 20, which may have an impermeable wall arranged in an octahedron, which may be used for a ring of a fish cage.

FIG. 23 shows a similar plane view of another ring structure formed of octahedral cells of FIG. 19 and connected as shown in FIG. 21, having more freedom to follow sea waves while floating on the surface.

FIG. 24 illustrates a special joint where three compression members are connected together. This can be used at the point where three compression members meet in the center of the combined basic hexagonal tensegrity element of FIG. 13a.

FIG. 25 shows three winches attached to the end of one compression member.

FIG. 26 illustrates one solution to how a linear actuator can be used to adjust the length or/and tension of said tension elements.

### DETAILED DESCRIPTION OF THE INVENTION

The invention hereby presented is marine installations using tensegrity structures with proper sensing, actuation and control to provide flexibility and adaptivity to fish farming and aquaculture installations.

A fish farming installation (100) can be described as a three dimensional structure (101) spanning a net (90) comprising a number of fish. Said three-dimensional structure (101) can have several shapes and only a few embodiments will be presented. We define a ring shaped structure (102), a closed, e.g. tubular or spherical or similarly shaped generally closed structure (103) and a generally hemispherical shaped structure (104).

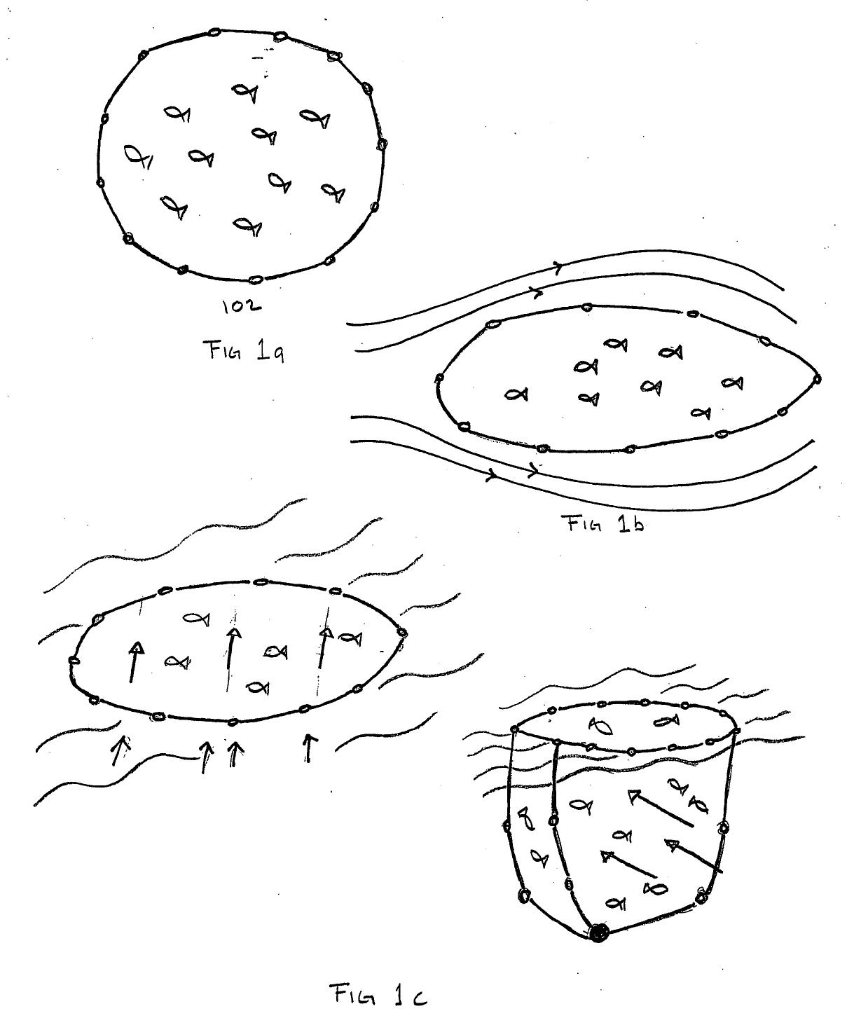

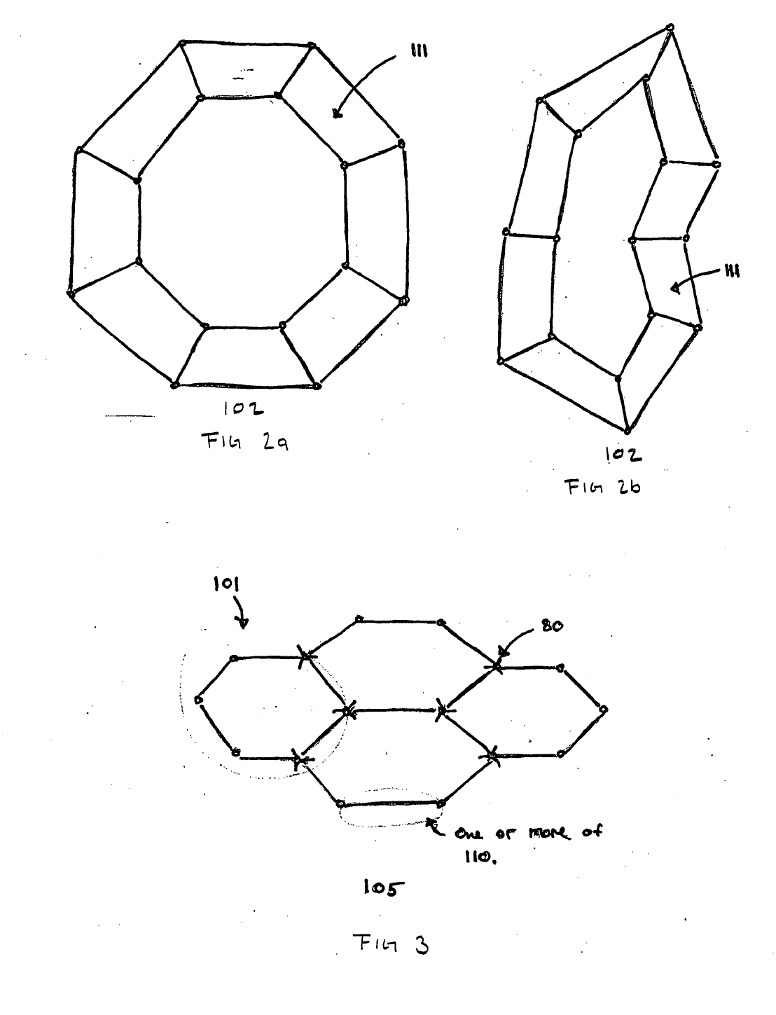

FIG. 1a and FIG. 1b illustrates a rough overview of said ring shaped structure (102) arranged for changing shape either passively by flexible deformation or by using active control to minimize environmental loads, i.e. wind, waves and currents. FIG. 1c illustrates a shape that maximizes the area exposed to water through-flux for improved water exchange conditions within the said fish farming installation. FIG. 1c also illustrates one embodiment of said three dimensional structure (101) that spans said net (90).

FIG. 2a illustrates another embodiment of said ring shaped structure (102) built by using a number of basic elements (110). The basic element (110) may in this case be any basic tensegrity element (111). FIG. 2b illustrates how a said ring shaped structure (102) can be deformed or actively change shape due to deformation or actively change of shape of said basic elements (110). Said basic tensegrity element (111) is normally an good candidate for shape control that will be utilized in fish farming installations (100) according to the invention built on the further developed concept of tensegrity structures.

FIG. 3 illustrates an interconnected structure (105). Said interconnected structure combines several of said three dimensional structures (101) of desired shape. The individual three dimensional structures (101) may be connected by joints (80). Externally forced relative motion between said three dimensional structures (101) can be exploited by integrating energy generators arranged for converting mechanical energy e.g. due to a varying length of tensile elements or rotational relative movements about said joints (80) to e.g. electrical energy.

The length and tension of said tension members (2) can be changed by linear actuators (25) or winches (26). Said linear actuators may rather slender and may be arranged within or arranged about a compression member (1). Winches (26) may be arranged at an end of a compression member (1), see Fig. FIG. 25, or remotely from said compression members (1) for transferring wire tension e.g. using a wire-and-hose mechanism.

In an alternative embodiment, we provide also compression members arranged so as for the length of said compression members (1) to be changed by hydraulic pistons or linear actuators using motors, see FIG. 26.

An overall first control system (75) for the fish cage (0, 70, 72, 74) according to the invention is arranged for receiving sensor signals (760) from first sensors (76) arranged for sensing tension force in tension elements (2), and also for sensing the actual length of extension for tension elements (2). Said control system (75) may also be arranged for receiving second sensor signals (770) from second sensors (77) arranged for sensing the compressive force in compressive elements (1). The overall control system (75) should have information about the actual length of all compressive elements (1) and all tensile elements (2). The overall control system (75) is then arranged to calculate the shape of all basic elements (600, 700), and thus the overall shape and size of the entire fish cage (0, 70, 72, 74). Based on measurement of external environmental loads like wind direction, wind speed, wave directions, sea state, current direction and current speed, the control system (75) may then calculate how the lengths of specific tensile elements should change length in order to change the overall shape of the fish cage (0, 70, 72, 74). The control system (75) may receive command signals (780) from an operator command input console (78) about how the overall shape of the fish cage should be or be changed, e.g. for a transition of the shape from a moored confiuration as shown in FIG. 17a or 17c, to a more elongate and narrow shape for transport, either tugged like in FIG. 17b or 17d. The control system (75) may calculate a shape that minimizes wave or current action of external forces acting on the fish cage (0, 70, 72, 74) to avoid damage of parts or the entire structure.

The overall control system (75) may then provide control signals (750) to actuators (25, 26) for changing the tension or length, or both, of specific tension elements (2) that should change said tension and/or length. Alternatively, said control system (75) may provide said control signals (750) to second control systems (85) arranged for specific cells for changing shape according in order to fit into the overall desired shape. Locally, in said tensile elements (2) receiving said control signals (750) for changing its tensile force or extended length, the subordinate control system (85) may be arranged for receiving said sensor signals (760) from first sensors (76) arranged for sensing the tension force in tension elements (2), and also for sensing the actual length of extension for tension elements (2), and provide control signals locally to the actuators (25, 26) in order for the local tensegrity element to achieve its shape or size commanded from the overall first control system (75).

In order to make the entire structure more rigid, all tensile elements may be tightened, or slackened in order to reduce the rigidity of the overall structure. In order to change tension of some tensile elements, and thus the shape of a local tensegrity cell, some of the compressive elements may be provided with actuators like hydralulic pistons or electric motors acting on said compressive elements to change their lengths.

Sensor signals and command signals could be sent as acoustic, radio, optical or electricalsignals through the water or through conductors in said tension members (2) and/or said compression members (1).

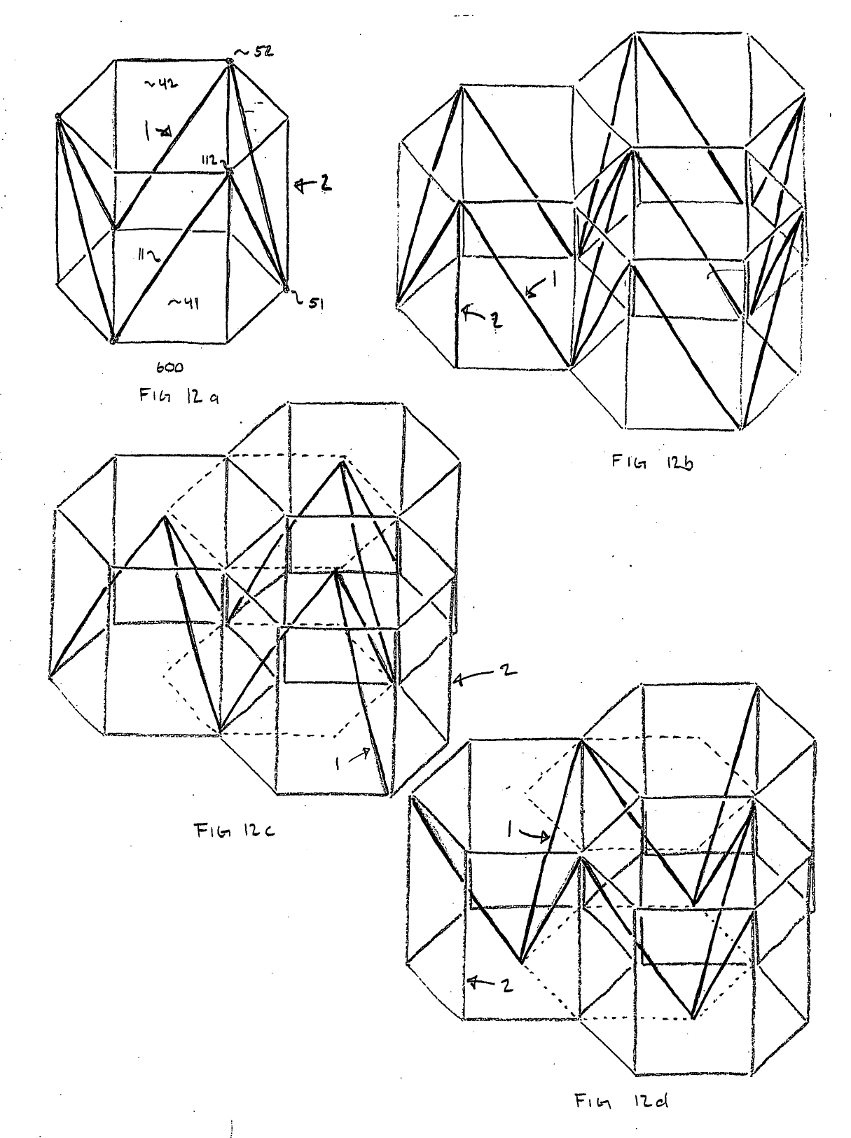

FIG. 8 illustrates a basic pentagonal cell (500) and a basic hexagonal cell (600) according to the invention, for forming part of a closed structure (74). By changing the width of a desired number of such basic hexagonal cells as shown in FIG. 9, the radius may be changed between a collapsed-state radius (rc) and an expanded or “deployed” radius (rd). This feature may provide that a fish cage according to the invention may be contracted to a small radius, e.g. between 2 and 6 metres, for being tugged or lifted onto a ship's deck and transported to a desired site, and when positioned in the sea at the desired site, to be expanded to a radius of more than 10 to 20 metres or more, in order to expand an attached spanned net (90) to form a large fish cage for use in the actual aquaculture. FIG. 10 and FIG. 11 illustrates a cell-radially contracted and expanded basic subcell (31, 32, 33) according to the invention. This basic subcell will be explained below.

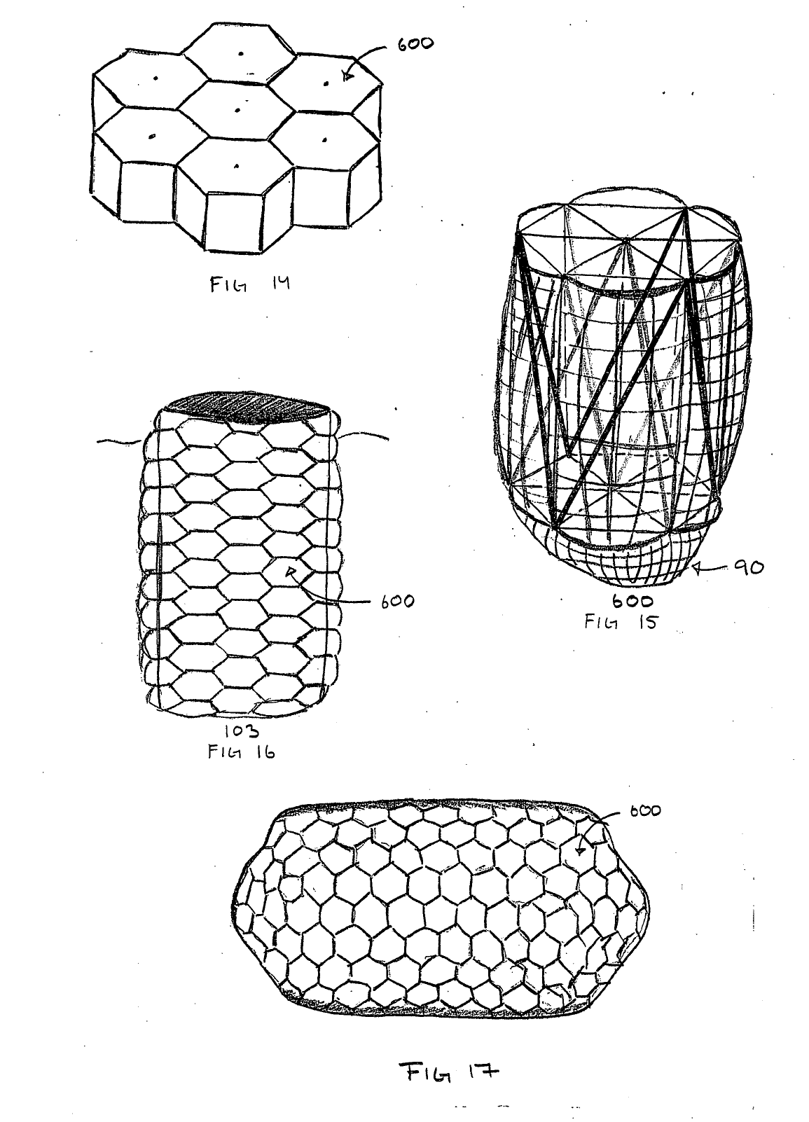

One preferred embodiment of a complete basic hexagonal cell (600) according to the invention, comprising a side-shifted combination of three the basic subcells (31, 32, 33) is shown in FIG. 13a, and is described in detail below. This basic hexagonal cell can be contracted sidewards (and will expand radially) as shown in FIG. 13c, but the effect of the sidewards contraction is that the radius of an entire structure formed by such basic cells will contract to (rc) as illustrated in FIG. 9 mentioned above. The basic hexagonal cell may, from a more or less contracted state as described above, be transformed to flatten in the basic cell's radial direction to be widened to a structural radius (rd) as shown in FIG. 9 and in FIG. 11 and in FIG. 13b.

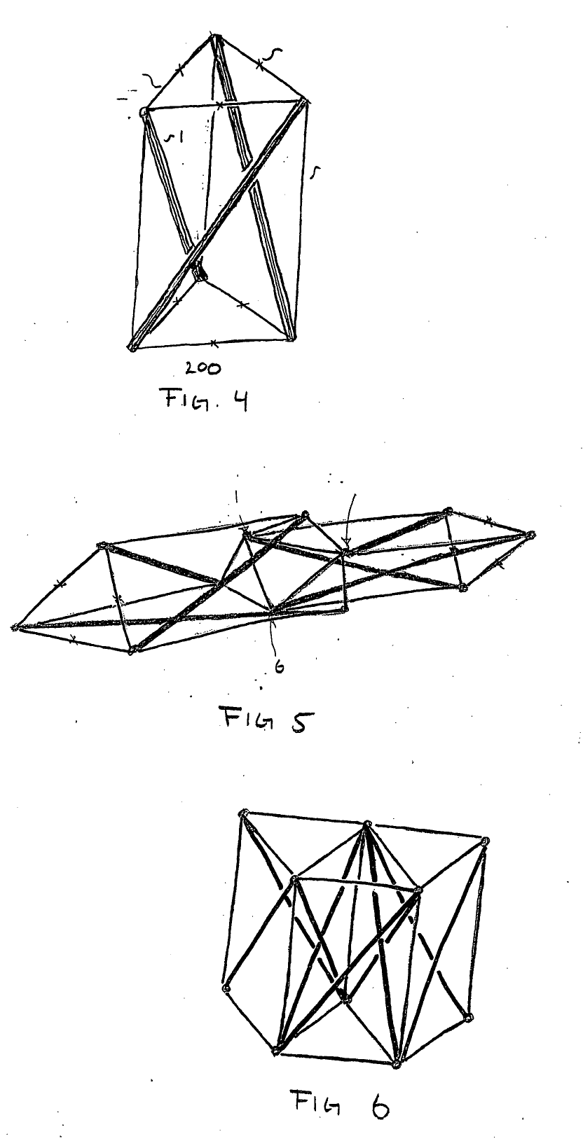

We now describe one said basic tensegrity element (111) first presented by Snelson in U.S. Pat. No. 3,169,611. This said basic tensegrity element (111) is defined three struts tensegrity element (200) and is illustrated in FIG. 4. The said three struts basic tensegrity element (200) consist of three said compression members (1) crossing intermediate in a tension network consisting of nine said tension members (2).

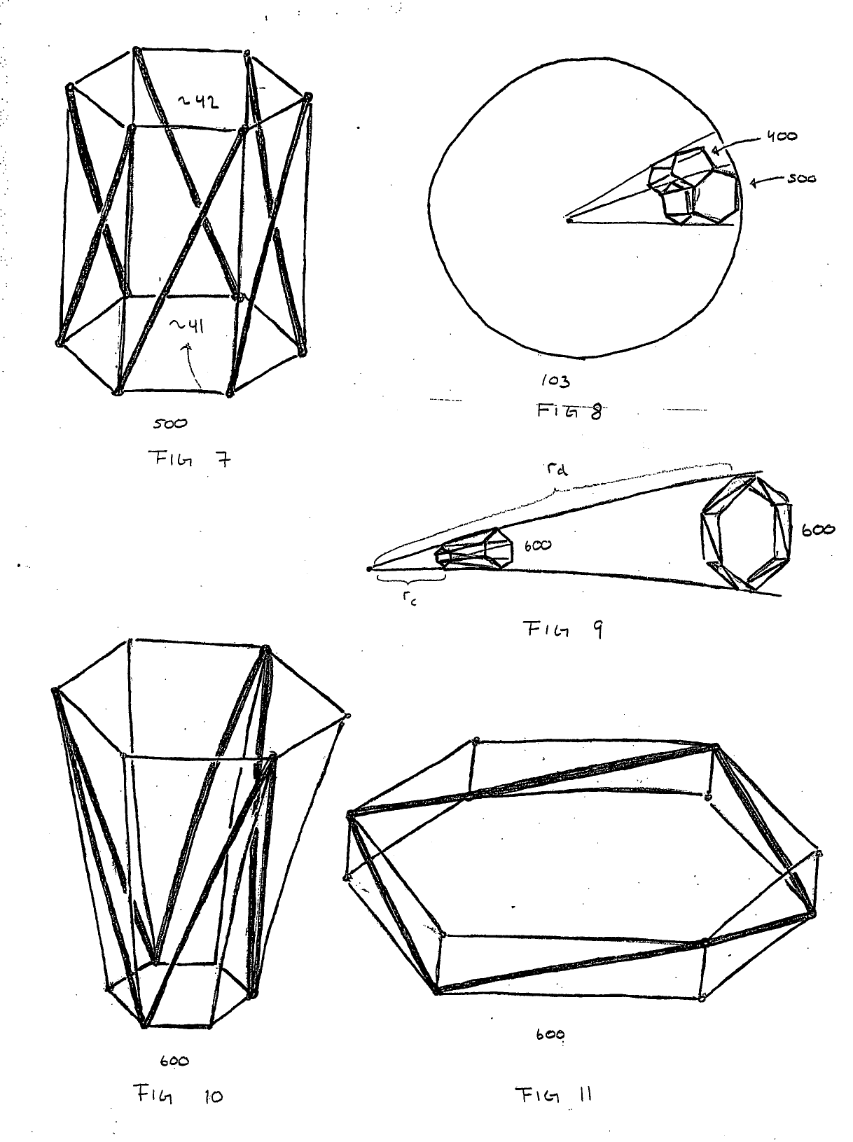

In the present invention we exploit the possibility of changing the shape of this said three struts basic tensegrity element (200) by adjusting the length of the said tension members (2) in a coordinated manner. The said three struts basic tensegrity element (200) can change shape to be low (or high) by lengthening (or shortening) the horizontal tension members (5) both at the top and the bottom and lengthening (or shortening) the vertical tension members (4). FIG. 6 also show at which points (6) this three struts basic element (200) could be interconnected with equal said basic tensegrity elements (111).

FIG. 5 illustrates how two said three struts basic tensegrity elements (200) could be connected in the said points (6) on top of one another. One possible said ring shaped structure (102) can be constructed by connecting a finite number of said three struts basic tensegrity elements (200) together in a ring. The possibility of shape change in each said three struts basic tensegrity element (200) give this said ring shaped structure (102) of said three struts basic tensegrity elements (200) an extraordinary freedom an flexibility to control shape, motion, vibrations and stiffness.

A basic hexagonal subcell (300, 31, 32, 33), according to the present invention, please see FIG. 11, may be used for assembling a basic hexagonal cell (600) (please see FIG. 13a) for building said spherical shaped structures (103) and hemispherical shaped structures (104).

We desired to build these structures by using hexagonal and pentagonal said basic tensegrity elements (111) interconnected similar to a football. See FIG. 8. We first tried pentagonal and hexagonal said basic tensegrity elements (111) similar to the one illustrated in FIG. 7. We call them pentagonal basic tensegrity element (400) and hexagonal basic tensegrity element (500) respectively. By proper control of such said pentagonal basic tensegrity elements (400) and said hexagonal basic tensegrity elements (500) we desired to control the shape and volume of one kind of said spherical shaped structure (103) illustrated in FIG. 9.

We realized conflicts both between neighboring such pentagonal basic tensegrity elements (400) and/or said hexagonal basic tensegrity elements (500) due to mechanical cross-contact of said compression members (1). The direction of the diagonally arranged compression member may be changed to avoid conflicting directions between two adjacent cells, but the third cell introuduced adjacent to the two first cells may not satisfy the direction of both first cells simultaneously. This same shortcoming is illustrated in FIG. 6 for neighboring said three struts basic tensegrity elements (200) of Snelson's U.S. Pat. No. 3,169,611 mentioned above.

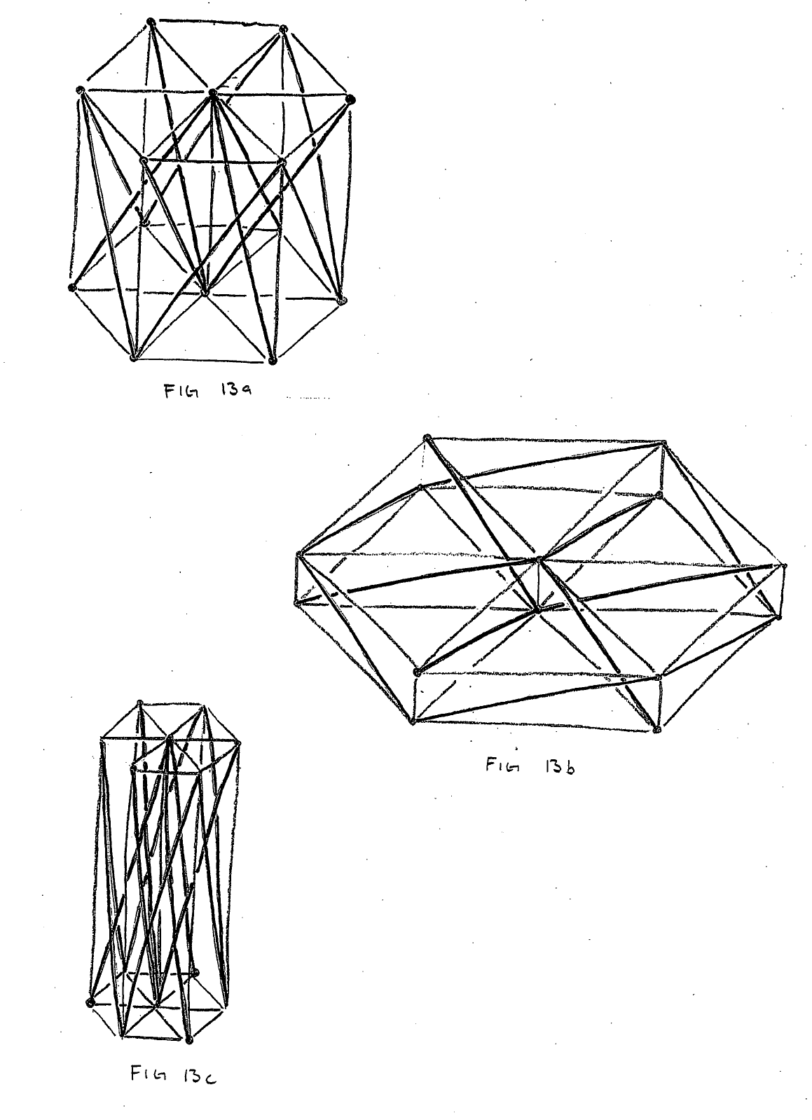

A reconfiguration of the said hexagonal basic tensegrity element (31, 32, 33) of a generally prismatic outline was done according to FIG. 12a. Said diagonally arranged compressive members (1) in the six side surfaces are connected end-on-end in nodes (112) arranged interchangeably in the upper and the lower hexagon. Now placed in a sawtooth or crown-like pattern. This structure is not stable in itself. This basic hexagonal tensegrity element (31, 32, 33) is imagined to be repeated along the direction parallel to and between the hexagonal planes (and removing doubling compression members arising from the repetition. Thus upper nodes (52) will connect three compressive member's (1) upper ends, and lower nodes (51) would connect three compressive member's lower ends.

According to the invention we define the new combined basic hexagonal tensegrity cell (600) by combining three such repeated patterns of the basic tensegrity element (31, 32, 33). See FIG. 12a, FIG. 12b, FIG. 12c, FIG. 12d and FIG. 13. A tensegrity structure of compressive elements (1) and tension elements (2) comprises first, second and third basic cells (31, 32, 33) combined to form one or more hexagonal structures.

The three basic cells (31, 32 33) comprise six rods (11) arranged with a first (lower) end (111) of a next compressive element (11) adjacent to a second (upper) end (112) of a first compressive element (11) as first (lower) and second (upper) nodes (51, 52) forming a hexagonal ring, as shown in FIG. 11 and explained above. Every second node (51, 52) is arranged in a first or “lower” or “inward-facing” hexagonal plane (41) and a second or “upper” or “outward-facing” hexagonal plane (42), respectively, forming a ring-shaped sawtooth-pattern. Each such basic hexagonal cell may then be extended to any side to form a triangular open pyramid pattern (having no volume) formed by said compressive elements.

The three patterns comprising basic cells (31, 32, 33) are then displaced relative to each other along said (upper or lower) planes (41, 42) by a half-width of said basic cell, basic cell (32) in the direction of a first hexagonal side of basic cell (31), and basic cell (33) in the direction of a second hexagonal side of basic cell (31). In this way, a first (lower) node (51) of said second basic cell (32) is placed between said three first (lower) nodes (51) in said first plane (41) of said first basic cell (31). A second (upper) node (52) is placed between said three first (upper) nodes in said second (upper) plane (42) in said first basic cell (32).

The nodes (51) of said first (lower) plane are connected by first tension elements (21) to each six neighbour nodes (51) in said (lower) first plane (41).

The nodes (52) of said second (upper) plane are connected by first tension elements (21) to each six neighbour nodes (52) in said (upper) second plane (41). This completes tensile connections along the hexagonal planes.

The nodes (51) are also connected by second tension elements (22) arranged in a direction perpendicular between said first (lower) and second (upper) planes (41, 42) to corresponding nodes (52) in said second plane (42). This direction may be called “vertical” in FIG. 12, and completes connection of nodes in the “lower”, or “inward facing” hexagonal tile pattern with nodes in the “outer”, or “outward facing” hexagonal tile pattern.

One purpose of the above mentioned structure is to form a static tensegrity elementary structure. The structure may also be arranged to change its shape, or size, or both, by changing the length of tension elements (2) or compressive elements (1).

FIG. 13a. illustrates said new combined basic hexagonal tensegrity cell (600) when the length of said vertical tension members (4) have been shortened (or lengthened) and the length of said horizontal tension members (5) have been lengthened (or shortened) to give this flat and broad (or high and thin) shape.

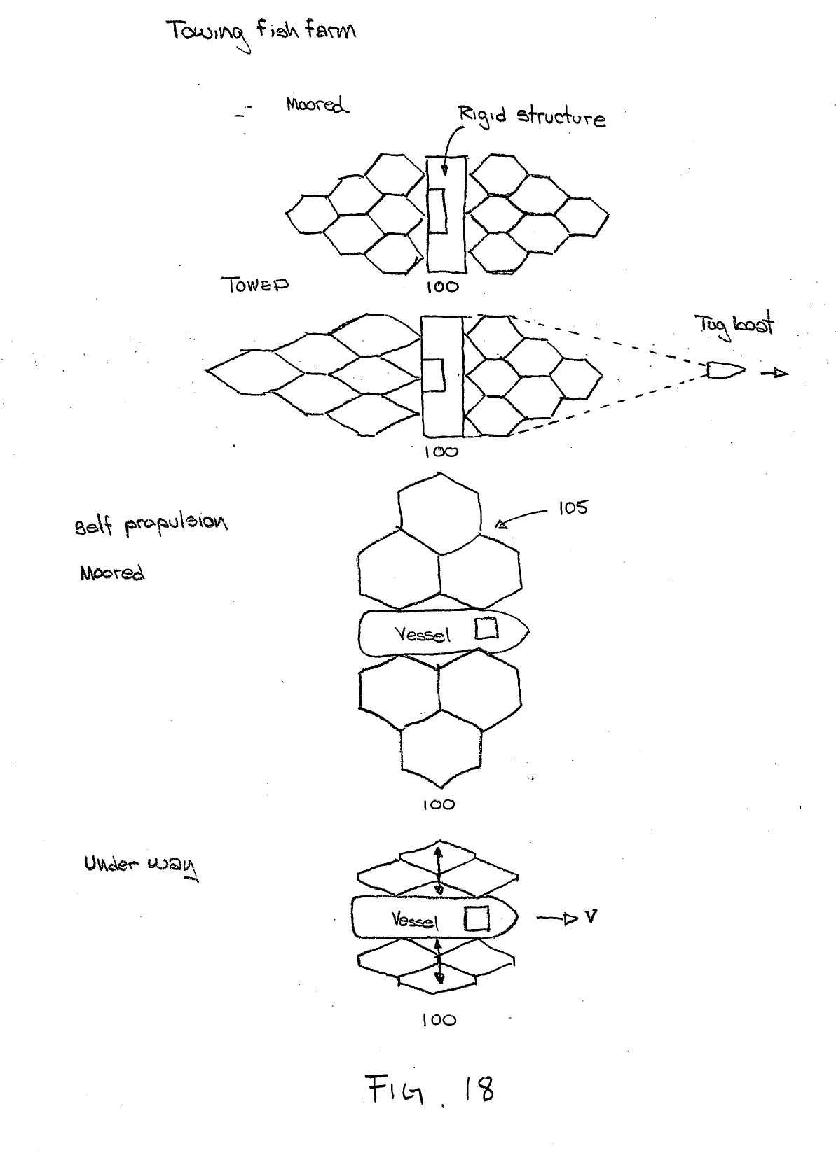

Said new combined basic hexagonal tensegrity cell (600) can be used in several ways to form said three dimensional structures (101). FIG. 14 illustrates seven said new combined basic hexagonal tensegrity cells (600) connected together side by side. This could for example be seven large said fish cages (0) connected together, a large said fish cage (0) or only part of a larger weave-pattern in a tube shaped structure (74) or the like. FIG. 15 shows one single new combined basic hexagonal tensegrity cell (600) used as a said fish cage (0) spanning a said net (90). FIG. 16 shows one possible said tube shaped structure (74) made by connected new combined basic tensegrity cells. FIG. 17 show another tube shaped structure (103) of which the wall is formed by such basic hexagonal transegrity cells (600).

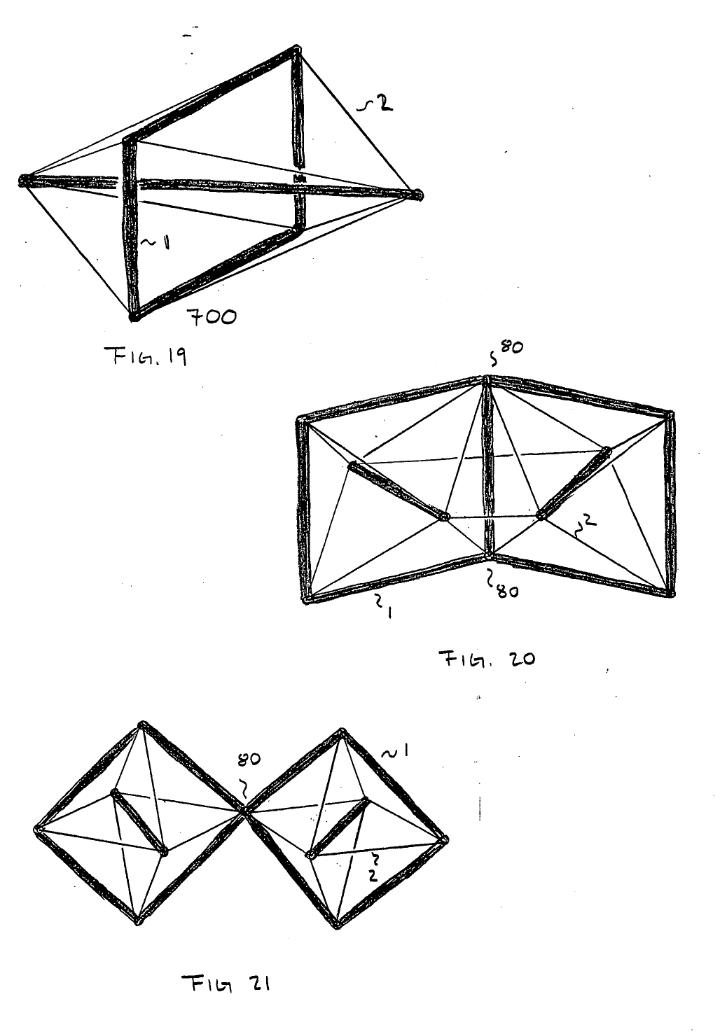

FIG. 18 gives some conceptual drawings of said interconnected structures (105). The illustrations show how structures can be compressed or deformed while moved.

FIG. 19 show a basic tensegrity element (111) of Passera and Pedretti defined as the octahedral cell (700). The octahedral cell (700) comprises of five said compression members (1), four of them connected in the said nodes (112) to form a square or rectangular shaped area. This area could be an impermeable surface or a said net (90). The fifth compression member (1) is connected by eight said tension members (2) in such a way that it is held orthogonal to the area formed by the afore mentioned four said compression members (1).

The described said octahedral cell (700) is used as a said basic tensegrity element (111) in a said ring shaped structure (102). We have proposed two ways of interconnecting this said octahedral cell (700) with its neighboring elements to from a said ring shaped structure (102).

FIG. 20 illustrates how two said octahedral cells (700) can be connected by two said joints (80) and two said tension members (2). A coordinated adjustment of the length and tension in the two said tension elements (2) would make the two neighboring elements move and change position with respect to one another. This can be utilized for shape, motion, vibration and stiffness control of the said ring shaped structure (102). This said ring shaped structure (102) will only be able to change shape in the horizontal plane due to the use of two said joints (80) between neighboring said octahedral cells (700). An illustration of such a said ring shaped structure (102) connected as shown in FIG. 20 can be seen from above in FIG. 22.

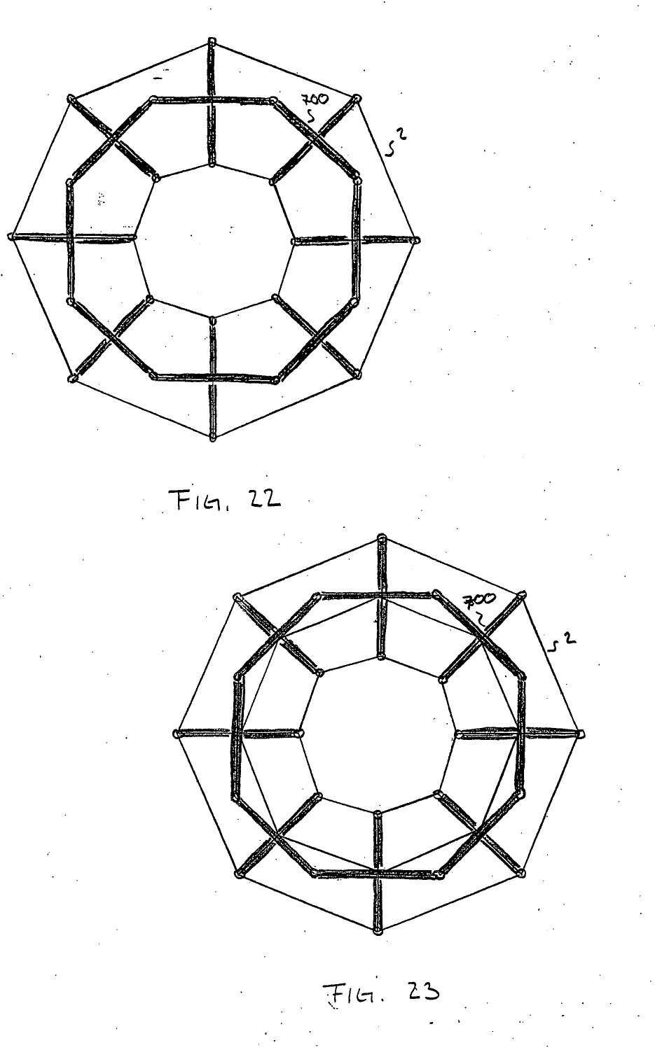

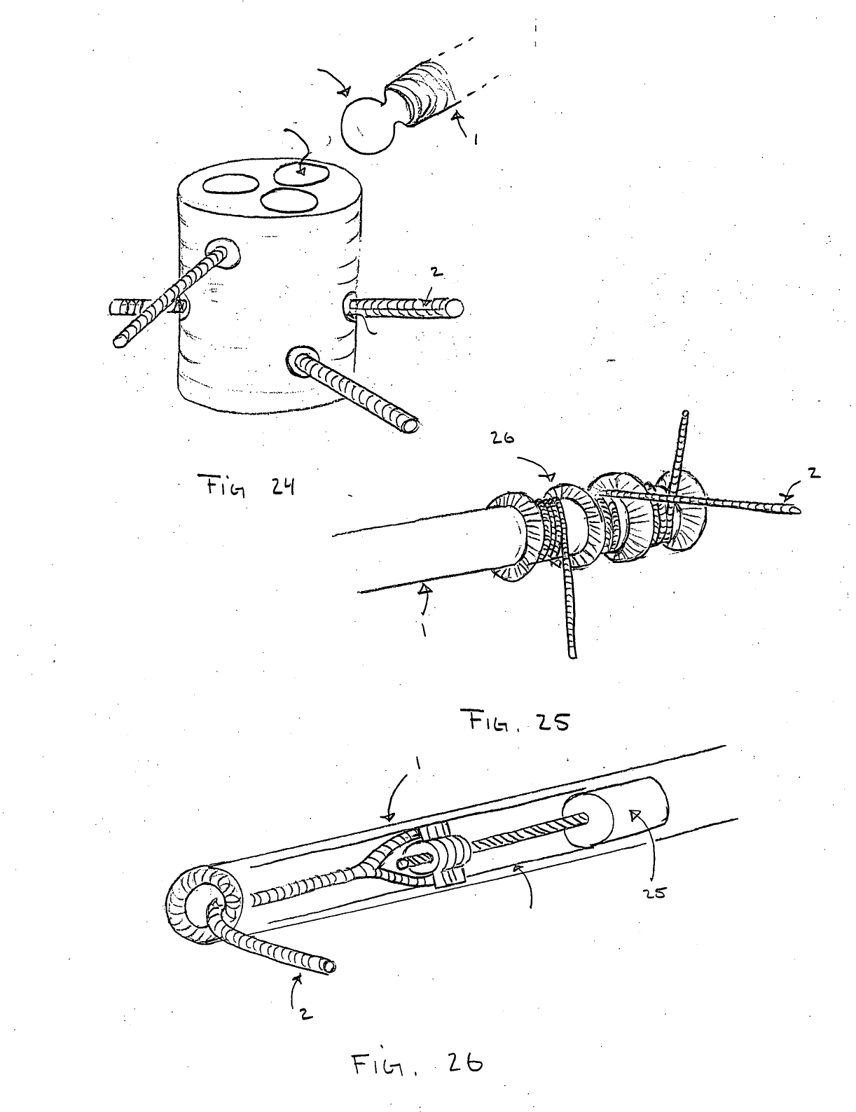

FIG. 21 illustrates another possible way of connecting two said octahedral cells (700), now with one said joint (80) and four said tension members (2). This give the ability of controlling shape, motion, vibrations and stiffness both horizontally and vertically. An illustration of this said ring shaped structure is shown in FIG. 23.

1. A marine structure for a fish cage (0) for aquaculture, with a net (90) spanned by a tensegrity structure, comprising compressive elements (1), and tension elements (2).

2. The marine structure of claim 1, the tensegrity structure comprising one or more hexagonal cylindrical basic cells (3).

3. The marine structure of claim 1, the tensegrity structure forming a flexibley ring (70) for being arranged near the surface or under the surface of the sea, for spanning said net (90) suspended in the sea below the ring (70) for enveloping a number of fish.

4. The marine structure of claim 1, the tensegrity structure forming a flexible hemisphere (72) spanning said net (90), said hemisphere for partly or entirely enveloping the fish.

5. The marine structure of claim 1, the tensegrity structure forming a flexible closed, preferably tubular-structure (74) for spanning said net (90).

6. The marine structure of claim 1, the tensegrity structure being arranged for changing shape by adjusting the tension or length of the tension elements (2).

7. The marine structure of claim 1, the tension elements (2) being wires, ropes or the like.

8. The marine structure of claim 6, the tension elements (2) arranged for being adjusted by linear actuators (25) or winches (26).

9. The marine structure of to claim 7, in which linear actuators (25) and/or winches (26) are arranged for tensioning/hauling or giving slack on said tension elements (2).

10. The marine structure according to claim 9, in which said actuators (25) and/or winches (26) are arranged within, on, or about said compressive element (1).

11. The marine structure according to claim 9, in which said actuators (25) and/or winches (26) are arranged remotely from said compressive element (1).

12. The marine structure of claim 1, the compressive elements (1) being rods, bars, pipes, or similar.

13. The marine structure of claim 1, the tensegrity structure being arranged for changing shape by adjusting the length of the compressive elements (1).

14. The marine structure of claim 10, adjusting the length of the compressive elements (1) using hydraulic or pneumatic pistons or linear actuators using motors.

15. The marine structure of claim 8, having a first control system (75) for receiving sensor signals (760) from first sensors (76) arranged for sensing tension forces and extended length of tension elements (2), and for providing control signals (750) to said actuators (25, 26) for changing the tension and/or changing the length of said tension elements (2).

16. The marine structure of claim 15, said first control system (75) being arranged for calculate the shape of some or all basic elements (600, 700), and thus the overall shape and size of the entire fish cage (0, 70, 72, 74).

17. The marine structure of claim 16, said first control system arranged for receiving measurement of external environmental loads like wind direction, wind speed, wave directions, sea state, current direction and current speed, the control system (75) may then calculate how the lengths of specific tensile elements should change length in order to change the overall shape of the fish cage (0, 70, 72, 74) to a desired new shape.

18. The marine structure of claim 17, said first control system (75) arranged for receiving command signals (780) from an operator command input console (78) about how the overall shape of the fish cage should be or be changed.

19. The marine structure of claim 17, said control system (75) arranged for providing said control signals (750) to second control systems (85) arranged for specific cells for changing shape according in order to fit into the overall desired shape, said actuators (25, 26) receiving said control signals (750) for changing its tensile force or extended length, said second control system (85) arranged for receiving said sensor signals (760) from first sensors (76) arranged for sensing tension force in tension elements (2), and also for sensing the actual length of extension for tension elements (2), said second control system (85) for providing control signals locally to said actuators (25, 26) in order for said tensegrity element to achieve its shape or size commanded from the overall first control system (75).

20. The marine structure of claim 15, said sensor signals and command signals (750, 760) for being sent as acoustic, radio, optical or electrical signals through the water or through signal conductors in said tension members (2) and/or said compression members (1).

21. The marine structure according to claim 2, comprising a tensegrity structure of compressive elements (1) and tension elements (2) comprising first, second and third basic cells (31, 32, 33) combined to form one or more hexagonal structures, in which
said basic cells (31, 32, 33) comprising six rods (11) arranged with a first end (111) of a next compressive element (11) adjacent to a second end (112) of a first compressive element (11) as first and second nodes (51, 52) forming a hexagonal ring;
in which every second node (51, 52) is arranged in a first plane (41) and a second plane (42), respectively, forming a ring-shaped sawtooth-pattern;
said three basic cells (31, 32, 33) being displaced relative to each other along said planes (41, 42) by a half-width of said basic cell;
in which a first node (51) of said second basic cell (32) is placed between said three first nodes (51) in said first plane (41) of said first basic cell (31), and in which a second node (52) is placed between said three first nodes in said second plane (42) in said first basic cell)
said nodes (51) of said first plane connected by first tension elements (21) to each six neighbour nodes (51) in said first plane (41); and
said nodes (52) of said second plane connected by first tension elements (21) to each six neighbour nodes (52) in said second plane (41);
said nodes (51) connected by second tension elements (22) arranged in a direction perpendicular between said first and second planes (41, 42) to corresponding nodes (52) in said second plane (42);
so as for said structure being arranged to change its shape or size by changing the length of tension elements (2) or compressive elements (1).

22. The marine structure according to claim 1, said tensegrity structure comprising octahedral basic cells (700) comprising four first compressive elements (1) arranged in a quadrangular pattern forming generally a plane, and arranging a second compressive element (1) generally normal to said plane and through said quadrangle, and connecting a first end of said second compressive element (1) using four first tension elements (2) extending to the four corners of said quadrangle, and connecting a second, opposite end of said second compressive element (1) also using four second tension elements (2) extending to said four corners of said quadrangle.

23. The marine structure according to claim 22, said quadrangle spanning a net (90) or a portion of said net (90).

24. The marine structure of claim 22, said octahedral cells combined to a flexibly deformable ring (70) by a letting a side compressive element (1) of said quadrangle of one octahedral cell forming an adjacent side compressive element (1) of an adjacent quadrangle of an adjacent octahedral cell (700), and connecting said first ends of said second compressive elements (1) by a third tension element (2) for controlling the relative orientation of said second compressive elements (1) and thus the relative orientation of said connected quadrangles.

25. The marine structure of claim 22, said octahedral cells combined to a flexibly deformable ring (70) by connecting a corner of said quadrangle of one octahedral cell with an adjacent corner of an adjacent quadrangle of an adjacent octahedral cell (700), and connecting said first ends of said second compressive elements (1) by a third tension element (2) for controlling the relative orientation of said second compressive elements (1) and thus the relative orientation of said connected quadrangles.

26. A method for changing the shape of a marine structure like a fish cage (0) for aquaculture, with a net (90) spanned by a tensegrity structure, i.e. a structure comprising compressive elements (1), and tension elements (2),
said method comprising the steps of:
using a first control system (75) for receiving sensor signals (760) from first sensors (76) sensing tension forces and extended length of tension elements (2),
said first control system (75) using said sensor signals (760) and the size of said compressive elements (1) to calculate the shape of all basic elements (600, 700), and thus an overall present shape and a desired new shape and size of the entire fish cage (0, 70, 72, 74),
said control system (75) providing control signals (750) to actuators (25, 26) for changing the tension and/or changing the length of said tension elements (2),
so as for changing the overall shape of said fish cage (0, 70, 72, 74) to said desired new shape.

27. The method of claim 26, said first control system (75) arranged for receiving measurement of external environmental loads like wind direction, wind speed, wave directions, sea state, current direction and current speed, for calculating how the lengths of specific tensile elements should change length in order to change the overall shape of the fish cage (0, 70, 72, 74) to a desired new shape.
